(19) United States
(12) Patent Application Publication
(10) Pub. No.: US 2011/0166683 A1
(43) Pub. Date: Jul. 7, 2011

(54) Real Time WIP Optimizer

(75) Inventors: Vincent Vazquez, Poughkeepsie, NY (US); Jeffrey Paul Gifford, Hopewell Junction, NY (US); Dmitriy Shneyder, Hopewell Junction, NY (US)

(73) Assignee: INTERNATIONAL BUSINESS MACHINES CORPORATION, Armonk, NY (US)

(21) Appl. No.: 12/683,454

(22) Filed: Jan. 7, 2010

(51) Int. Cl. G06F 17/00

(52) U.S. Cl. 700/100; 700/111

(57) ABSTRACT

A method identifies a real time downstream to processing capability within a production environment using a computerized device. The processing sequences perform operations utilizing one or more tools. The method also determines if an upstream tool capacity is greater than a downstream tool capacity. When the upstream tool capacity is greater than the downstream tool capacity the method calculates an overlap value. The method then adjusts the run rate for the upstream tool to by dividing the run rate of the upstream tool by the overlap value. The method is a centralized system that references tool processing parameters to determine processing capability. In the cases where the upstream tool has a significantly shorter processing time than the downstream tool, the system is used to determine if value should be added at the upstream tool to avoid WIP build up at the downstream tool.

### BACKGROUND

The present invention relates to controlling work in process flows through a production environment, and more specifically, to a method that balances flow of work through a system based upon capacity of the tools in the manufacturing line.

One aspect of managing production environments relates to controlling work in process (WIP) due to different timing in the manufacturing process for differing tools. In addition, for a diverse product mix, shared resources, and maintenance requirements, WIP may be difficult to manage. In a manufacturing line, the potential exists for an upstream tool to have a capacity greater than that of the tool immediately following it. This discrepancy in capacity between the upstream tool and downstream tool inherently results in WIP buildup.

A process time window is a manufacturing process requirement where one or more operations must be completed within a period of specified length. Process time window violations can cause product rework or scrap in the event of WIP buildup. In some instance, a process time window may be established to prevent growth, oxidation, corrosion, evaporation, spoilage or any other degradation of a product, or the introduction of foreign matter. Regardless of whether a specific process time window has been established or not, it is preferred to move a wafer through a production line with minimal wait time between operations.

WIP buildup may occur due to several variables. Primarily, WIP buildup results from capacity differences between consecutive operations. However, WIP buildup may result from either scheduled or unscheduled repairs, transportation of work between tools, and variations in process steps. For example, the processing time required for a tool may not be static and may vary based on the parameters of the specific process being performed by that tool. WIP buildup may occur due to differing processing requirements thereby changing the process times for individual tools. The differing process times may result in WIP buildup during certain processes and no WIP buildup in other cases.

In addition, WIP buildup may result due to Bank Releases, or releases of product from outside the standard process flow sequence into the manufacturing line. For example, in semiconductor manufacturing, a number of wafers from an alternate processing sequence may be introduced to a downstream tool. The result is that the upstream tool still processing wafers will create excessive wafers for the downstream tool resulting in WIP buildup.

The current state of the art methodology for managing WIP is through “Range Management”. Range Management breaks manufacturing flow into units called ranges. Each range has a daily run rate defined (WIP target), and assigned to the last tool in the range. When the target is exceeded, the range is stopped and nothing is allowed to enter the last tool in the range.

However, range management does not account for real time tool capacity variation within a range. In addition, throughput is not optimized and cycle time not minimized.

### SUMMARY

A method to manage WIP is necessary to minimize WIP buildup. To accomplish this step, the inventors propose a centralized system that references tool processing parameters to determine processing capability. In the cases where the upstream tool has a shorter processing time than the downstream tool, the system is used to determine if product should be processed at the upstream tool to avoid WIP buildup at the downstream tool.

One embodiment of the present invention is a method that determines the real time downstream processing capacity and a downstream toolset's fastest predicted run rate. The fastest predicted run rate may be determined as a standard deviation. For example a tool may run at a rate of 60 minutes per run. Assuming a normal distribution of run rate lengths, the tool may have a standard deviation of 5 minutes per run. This would result in the tool having a fastest predicted run rate of 45 minutes per run at a 99.7% confidence interval or three standard deviations (15 minutes) away from the mean. Similarly an upstream tool capacity and an upstream tool fastest predicted run rate is also determined.

Once the fastest predicted run rates are determined and the tool capacity both up and downstream are determined, a calculation is made to determine when the upstream tool capacity is greater than the downstream tool capacity. When the upstream tool capacity is greater the system adjusts the upstream tool capacity by slowing the upstream tool so the fastest predicted run rate of the upstream tool overlaps the fastest predicted run rate of the downstream tool.

In another embodiment, where the process time window is sensitive, the user may determine that the primary concern is the process time window and not the production rate. In this case, another embodiment is a method that determines the real time downstream processing capacity and a downstream toolset's slowest predicted run rate. The slowest predicted run rate may be determined as a standard deviation. For example a tool may run at a rate of 60 minutes per run. Assuming a normal distribution of run rate lengths, the tool may have a standard deviation of 5 minutes per run. This would result in the tool having a slowest predicted run rate of 75 minutes per run at a 99.7% confidence interval or three standard deviations (15 minutes) away from the mean. Similarly an upstream tool capacity and an upstream tool slowest predicted run rate is also determined.

Once the slowest predicted run rates are determined and the tool capacity both up and downstream are determined, a calculation is made to determine when the upstream tool capacity is greater than the downstream tool capacity. When the upstream tool capacity is greater the system adjusts the upstream tool capacity by slowing the upstream tool so the slowest predicted run rate of the upstream tool overlaps the slowest predicted run rate of the downstream tool.

In another embodiment, utilizing the method above, an additional step is added to monitor the WIP in the system. In the event excessive WIP buildup is detected, the upstream tool is further slowed until the WIP buildup level becomes acceptable.

Another embodiment of the present invention is a method that identifies when special cause components will occur and adjusts the upstream tooling to minimize WIP buildup during these operations. Special cause components may result from such events as preventative maintenance, unbanking product or releasing product to a downstream tool out of sequence, or delays caused for other reasons, such as weather related delays. It is possible to account for the special cause components, for example to implement preventative maintenance, without affecting the total production targets by understanding the WIP. The process must take into account time sensitive processing sequences within a production environment. The processing sequences perform operations by utilizing one or more tools at each processing step. The method calculates the historical preventative maintenance means and standard deviations for every tool in the line. When a downstream tool needs preventative maintenance, the method shifts the distribution of the upstream tool's processing speed by an amount based on the historical mean plus or minus the standard deviations of preventative maintenance on that tool. For the most probable outcome, the shift of the upstream tool is by the mean of the predicted down time of the downstream tool. To minimize wasted time waiting for the downstream tool and maximize throughput, shift the upstream tool's processing speed by the left limit of the predicted down time (fastest predicted time for preventative maintenance). To minimize process time window related errors, shift the upstream tool's processing speed by the right limit of the predicted down time (slowest predicted time for preventative maintenance). The method once again determines the real time downstream processing capacity and the downstream tool's fastest predicted run rate as described above. The upstream tool's capacity and fastest predicted run rate are also determined. As before, a calculation determines when the upstream tool capacity is greater than the downstream tool capacity. The upstream tool capacity is adjusted by slowing the upstream tool so the fastest predicted run rate of the downstream tool overlaps the fastest predicted run rate of the upstream tool. Once the tool run rates match, the system determines when a special cause component is identified. When a special cause component is identified the system determines when the special cause component will occur and the duration. The run rate of the upstream tool is then reduced prior to the slow down time for a duration equal to slow down duration.

### BRIEF DESCRIPTION OF THE SEVERAL VIEWS OF THE DRAWINGS

FIG. 1 is a schematic diagram that illustrates a system utilized by embodiments herein;

FIG. 2A is a flowchart illustrating an embodiment utilizing the fasted predicted run rate

FIG. 2B is a flowchart illustrating an embodiment utilizing the slowest predicted run rate;

FIG. 3 is an example of the adjustments made according to the embodiment of FIG. 2.

FIG. 4 is a flowchart illustrating an embodiment for determining a standard deviation;

FIG. 5 is a flowchart illustrating an embodiment for managing excessive WIP buildup;

FIG. 6 is a flowchart illustrating an embodiment for managing special cause components;

FIG. 7 is an example of the adjustments made according to the embodiment of FIG. 6.

FIG. 8 is a representative hardware environment for practicing the embodiments of the invention.

### DETAILED DESCRIPTION

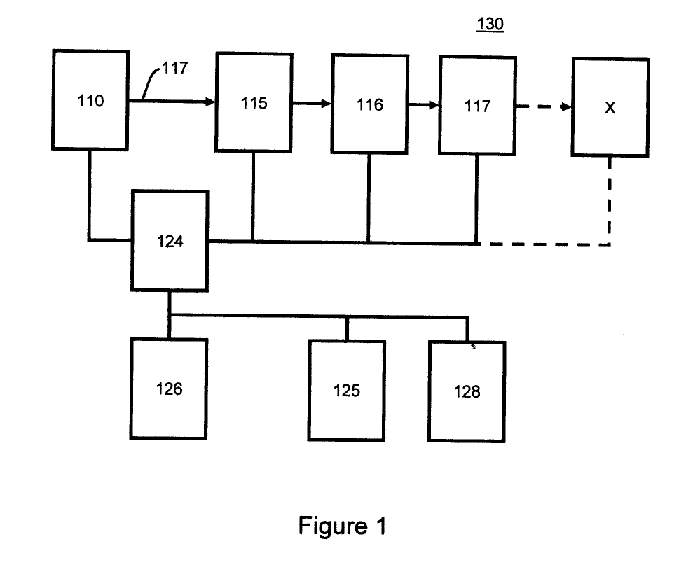

FIG. 1 is a schematic diagram that illustrates a production environment. Item 130 represents various resources and tools that are utilized within processing activity flows. The tools and resources include an upstream tool 110 and a downstream tool 115. A work flow path 117 between the upstream 110 and downstream 115 tool illustrates a simple flow between tools. While a simple flow is illustrated, in operation for example in a silicon wafer manufacturing facility, wafers may be transferred between tools in a FOUP (front opening universal pod). The FOUPS may be transported to holding stations until the downstream tool 115 is ready to process the wafers in the FOUP. In other embodiments the work flow path 117 may be as simple as a conveyor belt transferring the work product between the two tools. In this example, the concept of excessive WIP may be characterized by an excessive number of parts being produced at upstream tool 110 and literally piling up on the conveyor or work flow path 117. An extreme example of WIP out of control could be characterized by the skit by Lucille Ball about the candy machine. Upstream tools 110 and downstream tools 115 transform raw materials into intermediate and final products. The processor 126 performs the methods described below to direct a dispatcher 124. The dispatcher is operatively connected to the resources and tool 110, 115-117-x, the dispatcher directing the processing flows. A fabrication flow controller 125 and a scheduler 128 are operatively connected to the dispatcher and each other. The fabrication flow controller 125 determining a real time downstream processing capacity and a downstream tool fastest predicted run rate and an upstream tool capacity and an upstream tool fastest predicted run rate to manage the production rates of both upstream 110 and downstream 115 tools. While the system as modeled by the application will utilize only an upstream 110 and downstream tool 115, the methods taught may be applied to the entire manufacturing flow. Each segment may be modeled separately based on the “fastest” or “slowest” predicted run time, whichever is more important. As illustrated in FIG. 1, tools 116, 117 through tool x may implement the methods taught herein allowing for the balancing of the entire system.

Within such a production environment, certain processing activity flows that are applied to lots of work in process items must be completed within a certain processing time window or the work in process items may be destroyed or otherwise deteriorate or expire. For example in the example where a FOUP is utilized, wafers sitting in a FOUP for extended periods of time may be subject to oxidation, foreign matter accumulation, or film degradation, evaporation, or corrosion. Therefore, once a processing flow that has a processing time window limitation has begun, it must be completed within the time limit of the processing flow. For example, if one of the processing activities within a processing flow uses a tool to deposit a material that is easily oxidized, it may be necessary to cover the material with some form of insulator to prevent the material from oxidizing excessively. Thus, in this example, if the material is not covered with the insulator within the processing time window, the entire lot may suffer excessive oxidation and have to be scrapped.

One way to deal with process time windows is to manage each process time window independently by applying work in process limits for each processing flow. This method holds work in process prior to starting a processing flow until the work in process currently within the processing flow is below the limit. However, this method ignores the fact that some of the tools or resources within the processing flow are shared with other processing flows which creates the risk of releasing too much or too little work to the processing flow. In addition, with this method, work in process limits are based on the “planned” bottleneck operation, which risks releasing too much work in process to the processing flow when non-bottleneck tools are underperforming. Further, with this type of method, when new processing flows are established, it is necessary to set up bottleneck definitions and remain within work in process limits.

The problem of maintaining WIP control for a system which is also capable of handling special cause components, such as preventative or emergency maintenance and time constrained WIP, can occur in any manufacturing environments with multiple tools running at potentially different production rates.

The result is that the manufacturing system needs to be able to handle both steady state manufacturing and be adaptable to adjust for variations to the process. The system must be adaptable to handle the introduction of parts out of the normal sequence or a short term downstream delay. Therefore, various embodiments herein propose a methodology to manage the WIP through management of upstream tool production rates. The embodiments herein provide a process to determine the appropriate run rate of upstream tooling and to provide for delays in upstream production in the event of a variation in the normal run rate of the downstream tooling.

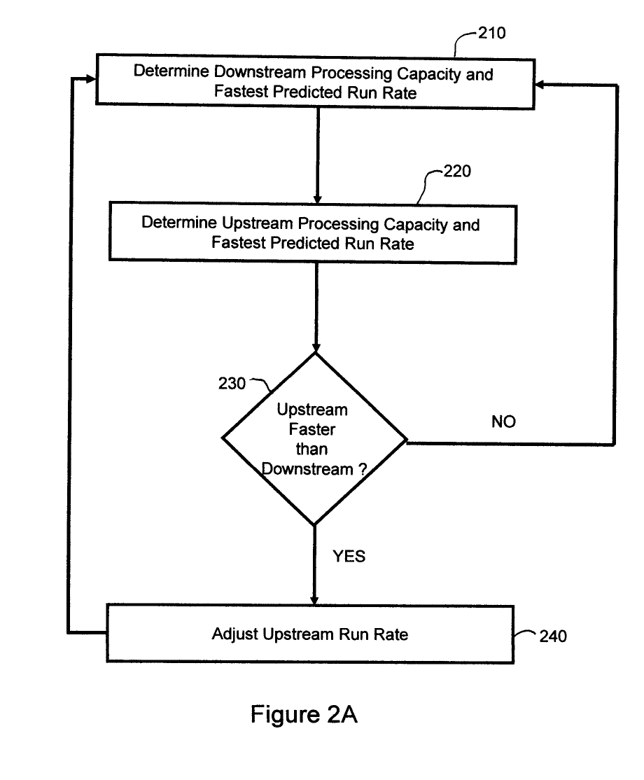

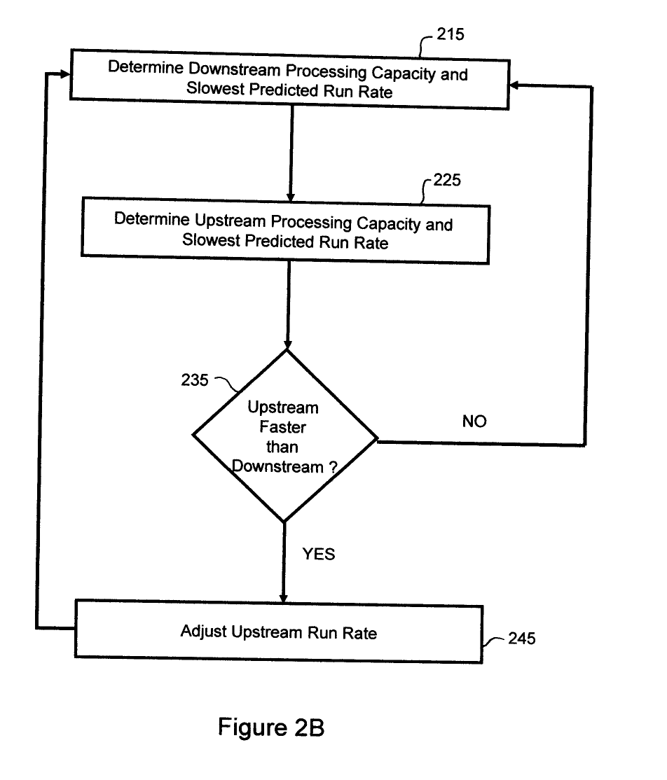

More specifically, as shown in flowchart form in FIG. 2A, the embodiments herein identify the differences in processing capacity of the upstream and downstream tools and adjust the upstream tool. The processing times of tools, however are not constant and tend to have variations. Step 210 comprises determining the downstream tools processing capacity and fastest predicted run rate. Step 220 comprises determining the upstream processing capacity and fastest predicted run rate. The capacity is determined by determining the amount of time to process the items being processed. Based on historical data the run rate is calculated, taking variation into account. The system also determines if the tool produces using batches or single items. For example the downstream tool may produce batches of 10 items at a time with a processing time of one hour plus or minus fifteen minutes for a 99.7% confidence interval, corresponding to the limit defined by plus or minus three standard deviations from the mean. Therefore the fastest predicted run rate would be 10 units in 45 minutes.

Step 230 determines if the fastest predicted run rate of the upstream tool is faster than the downstream tool. When this occurs, step 240 adjusts the upstream tool run rate such that the fastest predicted run rates of the two tools overlap, meaning that the upstream tool completes its production to provide the downstream tool with the processed product at the point when the downstream tool is ready to start its next cycle. Overlap as used in this application is defined as the run rates of production of the two tools having substantially similar values, those values being the slowest predicted run rates or fastest predicted run rates.

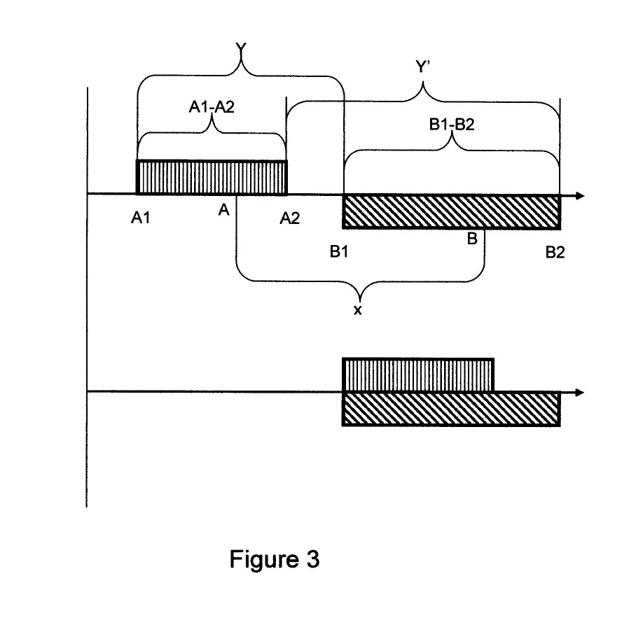

FIG. 3 illustrates the operation of the embodiment of the method shown in FIG. 2. FIG. 3 illustrates a simple case. In this case, the upstream tool or Tool A as illustrated takes 4-6 minutes to process a widget, represented by segment A1-A2. The downstream tool takes 8-12 minutes to process a widget, represented by segment B1-B2. The goal is for the upstream tool to slow down processing, so that tool B can catch up. The average time is represented by A (5 minutes) for the upstream tool and B (10 minutes) for the downstream tool.

The traditional approach takes x=B−A, and the output of the upstream tool is decreased by x, i.e. the new output becomes A+x.

The embodiment first defines the range of parts per hour (A1-A2 for the upstream tool, and B1-B2 for the downstream tool) at the 99.7% confidence interval. The upstream tool is then slowed down by y=(B1−A1). Taking the case above, tool A is slowed down by 8-4, and the new distribution for tool A becomes 8-10 minutes, and on average it will now take 9 minutes per widget. Clearly, this is different than the 10 minutes per widget obtained with the traditional approach.

In another embodiment, the tooling may utilize batch processing. The upstream tool A processes 20 widgets/hour, one widget at a time. The range is 19-21 widgets/hour at the 99.7% confidence interval. The downstream tool B processes 10 widgets/hour, all 10 widgets at one time. The range is 8-11 widgets/hour at the 99.7% confidence interval.

Using the above approach, the ranges are identified in the problem definition. Now, the shift is in the opposite direction because now we're dealing with parts per hour instead of time per widget. Y′=A2−B2=21−11=10, thus tool A will be shifted from 19-21 to 9-11 widgets/hour. (Note, in the segment representation, this time we're using the parts/hour definition, so the tool A is still the one being moved, but we're still using the faster limit, which is now the larger of the two numbers).

In another embodiment shown in flowchart form in FIG. 2B, the embodiments herein identify the differences in processing capacity of the upstream and downstream tools and adjust the upstream tool. The processing times of tools, however are not constant and tend to have variations. Step 215 comprises determining the downstream tools processing capacity and slowest predicted run rate. Step 225 comprises determining the upstream processing capacity and slowest predicted run rate. The capacity is determined by determining the amount of time to process the items being processed. Based on historical data the run rate is calculated, taking variation into account. The system also determines if the tool produces using batches or single items. For example the downstream tool may produce batches of 10 items at a time with a processing time of one hour plus or minus fifteen minutes for a 99.7% confidence interval, corresponding to the limit defined by plus or minus three standard deviations from the mean. Therefore the slowest predicted run rate would be 10 units in 75 minutes.

Step 235 determines if the slowest predicted run rate of the upstream tool is faster than the slowest predicted run rate of the downstream tool. When this occurs, step 245 adjusts the upstream tool run rate such that the slowest predicted run rates of the two tools overlap at the completion point to provide the downstream tool with the processed product at the point no sooner than when the downstream tool is ready to start its next cycle.

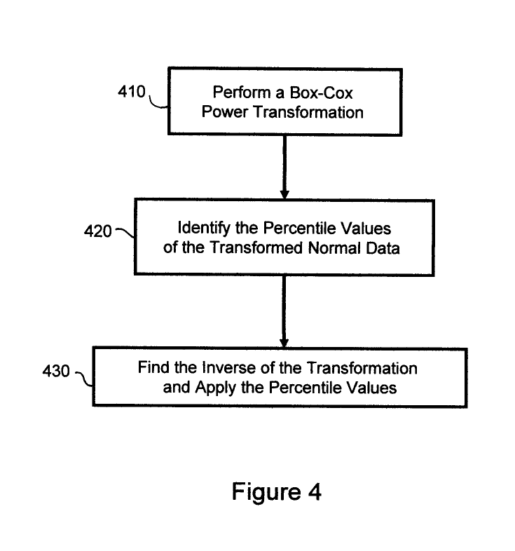

The process may also be derived using the percentiles (step 1 in the above approach). For a normal distribution, this can be easily defined by moving a number of standard deviations away from the mean. For example, if one moves +/−3 standard deviations away from the mean, 99.7% of all data will be included. However, most real distributions are not normal. One possible way of approaching such a distribution is to use the method of FIG. 4.

Step 410 may be to perform a Box-Cox power transformation to normalize the distribution. In statistics, the Box-Cox distribution (also known as the power-normal distribution) is the distribution of a random variable X for which the Box-Cox transformation on X follows a truncated normal distribution. Step 420 may be to identify the percentile values of the transformed normal data. Step 430 may be to find the inverse of the transformation and plug in the values from step 420. Alternatively, one could resort to fitting to the Johnson distribution, or any number of other methods, as published in the literature.

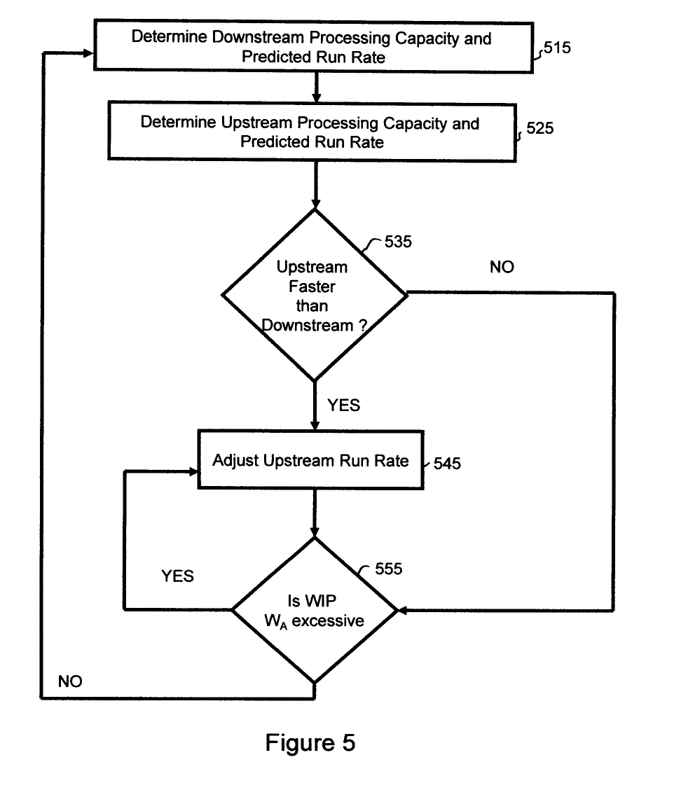

In a further embodiment as illustrated in FIG. 5, it may be that a WIP monitor may be incorporated. In this embodiment a delay mechanism may be utilized, based on WIP at downstream tool B (W_{A}). For example if we take the above embodiments, step 515 may be to determine the downstream tools processing capacity and the predicted run rates. In the case where speed is the primary driver the fastest predicted run rate of the upstream tool is determined. In the case where a process time window is involved, the slowest predicted run rate may be determined. In a similar manner step 525 may be to make the same calculations for the downstream tool. Once the calculations of steps 515 and 525 have been made, step 535 may be to determine if the upstream tool is producing product at a rate faster than the downstream tool. If this is the case step 545 may be to adjust the upstream tool run rate appropriately as taught in FIGS. 2A and 2B. If the upstream run rate is not faster or after completing step 545, step 555 may be to determine if there's already WIP in the amount of W_{A} in front of downstream tool B. Step 545 would then introduce a delay or slow down in the upstream tool A. To avoid excessive WIP the system may stop or delay processing on the upstream tool A for some period of time to allow downstream tool B to use the excessive WIP. This amount of time should be equal to however long it takes tool A to output WIP equal to W_{A}. Therefore the delay time for the upstream tool A, (T_{delay}) may be equal to the excessive WIP, W_{A}, divided by the average run rate of the upstream tool (A1). T_{delay}=W_{A}/A. The calculation A may be the mean of the processing time for the upstream tool A. In addition, it is possible that A may introduce the standard deviations based on whether speed is critical or a process time window is involved.

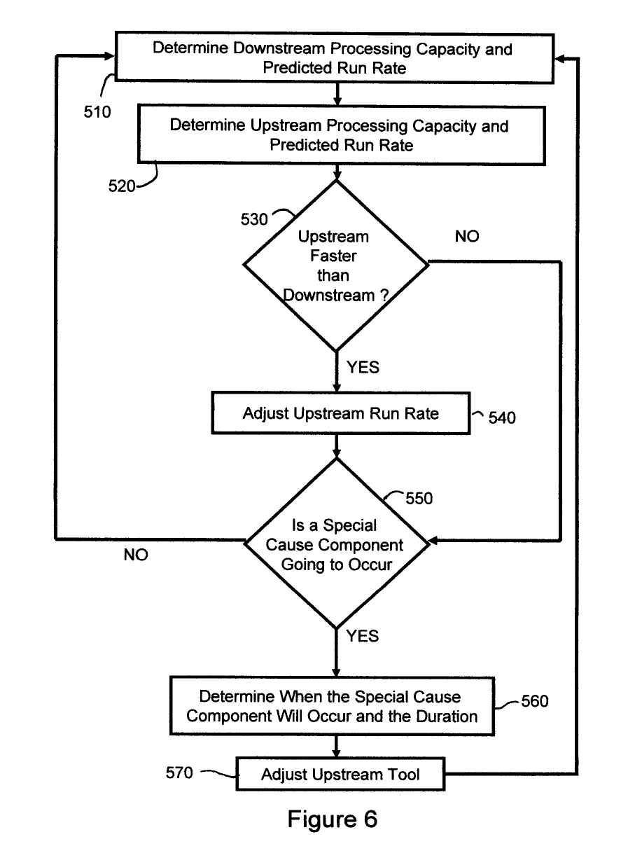

In another embodiment illustrated in FIG. 6 is a flow chart illustrating how the system manages special cause components. As shown in FIG. 6 step 510 may be to determine the downstream tools processing capacity and the predicted run rates. In the case where speed is the primary driver the fastest predicted run rate of the upstream tool is determined. In the case where a process time window is involved, the slowest predicted run rate may be determined. In a similar manner step 520 may be to make the same calculations for the downstream tool. Once the calculations of steps 510 and 520 have been made, step 530 may be to determine if the upstream tool is producing product at a rate faster than the downstream tool. If this is the case step 540 may be to adjust the upstream tool run rate appropriately as taught in FIGS. 2A and 2 B. After adjusting the run rate, if required, or in the event it is not required, step 550 may be used to determine if a special cause component will occur for the downstream tool. As discussed above, a special cause component may be for preventative maintenance, transportation delays, chemical installation, the introduction of unscheduled downstream parts, power failures, or other supply chain issues. In the event that these special cause components will occur, if there is sufficient notice, WIP may be controlled utilizing embodiments of this invention.

Step 560 may be used to determine when the special cause component will occur, a slow down time for the upstream tool, and slow down duration for the upstream tool. For example, in the event of an introduction of unscheduled downstream parts, for semiconductors, it may be referred to as unbanking wafers. When unbanked wafers are introduced, or wafers are introduced from an alternate upstream path, the slow down time will be the time when the unbanked wafers will be provided to the downstream tool. The slow down duration will be the processing time of the unbanked wafers.

Step 570 may be used to reduce production for the upstream tool at the slow down time for the slow down duration. Thereby the upstream tool introduces a delay which allows the downstream interruption to be completed, without excessive WIP.

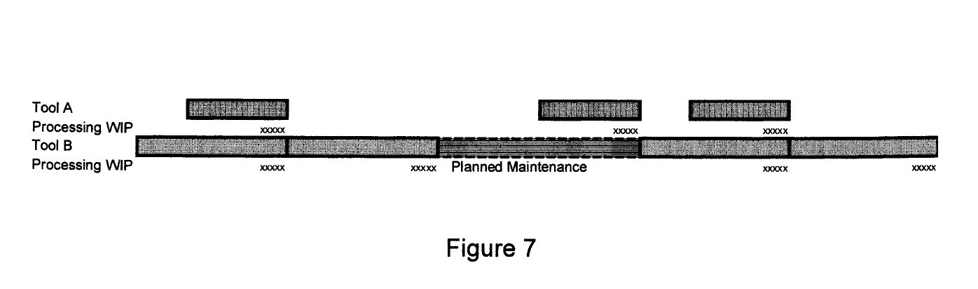

FIG. 7 is an example of the operation of the above embodiment. Similar to the example illustrated in FIG. 3, where the starting ranges are 19-21 widgets per hour for the upstream tool A and 8-11 for the downstream tool B, at the 99.7% confidence interval, tool A will have to slow down to 8-11 widgets/hour. In the event that a special cause component, preventative maintenance, needs to be performed on tool B, its 5 hours away, and it will take 1 hour +/−30 minutes. To avoid WIP the system adjust the reduction in parts per hour on Tool A, based on the length of the preventative maintenance and how far away it is. The system will adjust the run rate for the next 5 hours, with the goal of not having any parts in front of tool B as the preventative maintenance starts, and then process enough parts on the upstream tool A so that the operation on downstream tool B can begin as soon as it comes up from the preventative maintenance. If it's a batch tool, the entire batch should be available. However, if there are queue-time issues possible, tool B should enter the preventative maintenance with no WIP in front of it, and tool A not processing.

For instance, tool B has z widgets in front of it. The system may adjust the process such that when tool A makes 8-11 widgets/hour, tool B will not accumulate excess parts. But the goal is to get rid of all parts on tool B before the preventative maintenance begins.

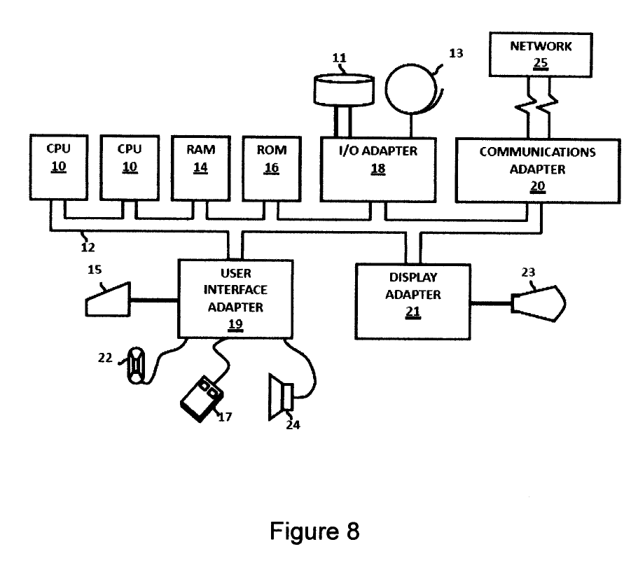

A representative hardware environment for practicing the embodiments of the invention is depicted in FIG. 8. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Deployment Types include loading directly in the client, server and proxy computers via loading a storage medium such as a CD, DVD, etc. The process software may also be automatically or semi-automatically deployed into a computer system by sending the process software to a central server or a group of central servers. The process software is then downloaded into the client computers that will execute the process software. The process software is sent directly to the client system via e-mail. The process software is then either detached to a directory or loaded into a directory by a button on the e-mail that executes a program that detaches the process software into a directory. The process software is sent directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server then stored on the proxy server.

While it is understood that the process software may be deployed by manually loading directly in the client, server and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively the process software is sent directly to the client system via e-mail. The process software is then either detached to a directory or loaded into a directory by a button on the e-mail that executes a program that detaches the process software into a directory. Another alternative is to send the process software directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server then stored on the proxy server.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
determining a real time downstream processing capacity and a downstream tool fastest predicted run rate;
determining an upstream tool capacity and an upstream tool fastest predicted run rate;
calculating when the upstream tool capacity is greater than the downstream tool capacity; and
adjusting the upstream tool capacity by slowing the upstream tool so the fastest predicted run rate of the downstream tool overlaps the fastest predicted run rate of the upstream tool.

2. The method of claim 1, wherein the downstream processing capacity and the upstream processing capacity comprises variations.

3. The method of claim 2, wherein the variations comprise random components.

4. The method of claim 2, wherein the variations comprise special cause components.

5. The method of claim 1, wherein the downstream processing capacity comprises batch processing capabilities.

6. The method of claim 1, wherein the upstream processing capacity comprises batch processing capabilities.

7. The method of claim 6, wherein the upstream tool capacity may be adjusted by reducing a number of units processed in a batch.

8. The method of claim 7, wherein the downstream processing capacity and the upstream processing capacity include variations.

9. The method of claim 3, wherein the processing variations are calculated as standard deviations and the fastest predicted run rate is determined as a number of standard deviations away from an average process variation.

10. A method comprising:
determining a real time downstream processing capacity and a downstream tool fastest predicted run rate;
determining an upstream tool capacity and an upstream tool fastest predicted run rate;
calculating when the upstream tool capacity is greater than the downstream tool capacity;
adjusting the upstream tool capacity by slowing the upstream tool so the fastest predicted run rate of the downstream tool overlaps the fastest predicted run rate of the upstream tool;
determining that a special cause component will occur for the downstream tool;
determining when the special cause component will occur, a slow down time for the upstream tool, and slow down duration for the upstream tool; and
reducing production for the upstream tool at the slow down time for the slow down duration.

11. The method of claim 10 wherein reducing production is stopping production.

12. The method of claim 10 wherein the special cause component is predictive maintenance.

13. The method of claim 10 wherein the special cause component is due to unbanking wafers.

14. The method of claim 10 wherein the special cause component is due to weather related event.

15. The method of claim 10 wherein the special cause component is due to a delivery issue.

16. A computer program product comprising a computer readable storage medium having computer readable program code embodied therewith, the computer readable program code being configured to perform a method comprising:
determining a real time downstream processing capacity and a downstream tool fastest predicted run rate;
determining an upstream tool capacity and an upstream tool fastest predicted run rate;
calculating when the upstream tool capacity is greater than the downstream tool capacity; and
adjusting the upstream tool capacity by slowing the upstream tool so the fastest predicted run rate of the downstream tool overlaps the fastest predicted run rate of the upstream tool.

17. The method of claim 16, wherein the downstream processing capacity and the upstream processing capacity comprises variations.

18. The method of claim 17, wherein the variations comprise random components.

19. The method of claim 16, wherein the downstream processing capacity comprises batch processing capabilities.

20. The method of claim 16, wherein the upstream processing capacity comprises batch processing capabilities.

21. The method of claim 20, wherein the upstream tool capacity may be adjusted by reducing a number of units processed in a batch.

22. The method of claim 21, wherein the downstream processing capacity and the upstream processing capacity include variations.

23. The method of claim 18, wherein the processing variations are calculated as standard deviations and the fastest predicted run rate is determined as a number of standard deviations away from the average process variation.

24. A computer program product comprising a computer readable storage medium having computer readable program code embodied therewith, the computer readable program code being configured to perform a method comprising:
determining a real time downstream processing capacity and a downstream tool fastest predicted run rate;
determining an upstream tool capacity and an upstream tool fastest predicted run rate;
calculating when the upstream tool capacity is greater than the downstream tool capacity;
adjusting the upstream tool capacity by slowing the upstream tool so the fastest predicted run rate of the downstream tool overlaps the fastest predicted run rate of the upstream tool;
determining that a special cause component will occur for a downstream tool;
determining when a special cause component will occur, a slow down time for the upstream tool, and slow down duration for the upstream tool; and
reducing production for the upstream tool at the slow down time for the slow down duration.

25. A system comprising:
resources and tools utilized to execute processing flows, the tools and resources transforming raw materials into intermediate and final products;
a dispatcher operatively connected to the resources and tool, the dispatcher directing the processing flows;
a fabrication flow controller operatively connected to the dispatcher,
a scheduler operatively connected to the dispatcher and the fabrication flow controller,
the fabrication flow controller determining a real time downstream processing capacity and a downstream tool fastest predicted run rate and an upstream tool capacity and an upstream tool fastest predicted run rate;
the dispatcher calculating when the upstream tool capacity is greater than the downstream tool capacity; and
the dispatcher adjusting the upstream tool capacity by slowing the upstream tool so the fastest predicted run rate of the downstream tool overlaps the fastest predicted run rate of the upstream tool.

26. The system according to claim 25, wherein the dispatcher further determines when a special cause component will occur for a downstream tool;
the dispatcher determining when a special cause component will occur, a slow down time for the upstream tool, and slow down duration for the upstream tool; and
the dispatcher reducing production for the upstream tool at the slow down time for the slow down duration.

27. A method comprising:
determining a real time downstream processing capacity and a downstream tool slowest predicted run rate;
determining an upstream tool capacity and an upstream tool slowest predicted run rate;
calculating when the upstream tool capacity is greater than the downstream tool capacity; and
adjusting the upstream tool capacity by slowing the upstream tool so the slowest predicted run rate of the downstream tool overlaps the slowest predicted run rate of the upstream tool.

28. The method of claim 27, wherein the downstream processing capacity and the upstream processing capacity comprises variations.

29. The method of claim 28, wherein the variations comprise random components.

30. The method of claim 28, wherein the variations comprise special cause components.

31. The method of claim 27, wherein the downstream processing capacity comprises batch processing capabilities.

32. The method of claim 27, wherein the upstream processing capacity comprises batch processing capabilities.

33. The method of claim 32, wherein the upstream tool capacity may be adjusted by reducing a number of units processed in a batch.

34. The method of claim 33, wherein the downstream processing capacity and the upstream processing capacity include variations.

35. The method of claim 29, wherein the processing variations are calculated as standard deviations and the slowest predicted run rate is determined as a number of standard deviations away from an average process variation.

36. A method comprising:
determining a real time downstream processing capacity and a downstream tool slowest predicted run rate;
determining an upstream tool capacity and an upstream tool slowest predicted run rate;
calculating when the upstream tool capacity is greater than the downstream tool capacity;
adjusting the upstream tool capacity by slowing the upstream tool so the slowest predicted run rate of the downstream tool overlaps the slowest predicted run rate of the upstream tool;
determining that a special cause component will occur for the downstream tool;
determining when the special cause component will occur, a slow down time for the upstream tool, and slow down duration for the upstream tool; and
reducing production for the upstream tool at the slow down time for the slow down duration.

37. The method of claim 36 wherein reducing production is stopping production.

38. The method of claim 36 wherein the special cause component is predictive maintenance.

39. The method of claim 36 wherein the special cause component is due to unbanking wafers.

40. The method of claim 36 wherein the special cause component is due to weather related event.

41. The method of claim 36 wherein the special cause component is due to a delivery issue.

42. A computer program product comprising a computer readable storage medium having computer readable program code embodied therewith, the computer readable program code being configured to perform a method comprising:
determining a real time downstream processing capacity and a downstream tool slowest predicted run rate;
determining an upstream tool capacity and an upstream tool slowest predicted run rate;
calculating when the upstream tool capacity is greater than the downstream tool capacity; and
adjusting the upstream tool capacity by slowing the upstream tool so the slowest predicted run rate of the downstream tool overlaps the slowest predicted run rate of the upstream tool.

43. The method of claim 42, wherein the downstream processing capacity and the upstream processing capacity comprises variations.

44. The method of claim 43, wherein the variations comprise random components.

45. The method of claim 42, wherein the downstream processing capacity comprises batch processing capabilities.

46. The method of claim 42, wherein the upstream processing capacity comprises batch processing capabilities.

47. The method of claim 46, wherein the upstream tool capacity may be adjusted by reducing a number of units processed in a batch.

48. The method of claim 47, wherein the downstream processing capacity and the upstream processing capacity include variations.

49. The method of claim 44, wherein the processing variations are calculated as standard deviations and the slowest predicted run rate is determined as a number of standard deviations away from the average process variation.

50. A computer program product comprising a computer readable storage medium having computer readable program code embodied therewith, the computer readable program code being configured to perform a method comprising:
determining a real time downstream processing capacity and a downstream tool slowest predicted run rate;
determining an upstream tool capacity and an upstream tool slowest predicted run rate;
calculating when the upstream tool capacity is greater than the downstream tool capacity;
adjusting the upstream tool capacity by slowing the upstream tool so the slowest predicted run rate of the downstream tool overlaps the slowest predicted run rate of the upstream tool;
determining that a special cause component will occur for a downstream tool;
determining when a special cause component will occur, a slow down time for the upstream tool, and slow down duration for the upstream tool; and
reducing production for the upstream tool at the slow down time for the slow down duration.

51. A system comprising:
resources and tools utilized to execute processing flows, the tools and resources transforming raw materials into intermediate and final products;
a dispatcher operatively connected to the resources and tool, the dispatcher directing the processing flows;
a fabrication flow controller operatively connected to the dispatcher,
a scheduler operatively connected to the dispatcher and the fabrication flow controller,
the fabrication flow controller determining a real time downstream processing capacity and a downstream tool slowest predicted run rate and an upstream tool capacity and an upstream tool slowest predicted run rate;
the dispatcher calculating when the upstream tool capacity is greater than the downstream tool capacity; and
the dispatcher adjusting the upstream tool capacity by slowing the upstream tool so the slowest predicted run rate of the downstream tool overlaps the slowest predicted run rate of the upstream tool.

52. The system according to claim 51, wherein the dispatcher further determines when a special cause component will occur for a downstream tool;
the dispatcher determining when a special cause component will occur, a slow down time for the upstream tool, and slow down duration for the upstream tool; and
the dispatcher reducing production for the upstream tool at the slow down time for the slow down duration.
